(19) United States
(12) Patent Application Publication
(10) Pub. No.: US 2026/0147453 A1
(43) Pub. Date: May 28, 2026

(54) DISPLAY CONTROL DEVICE AND METHOD

(71) Applicant: Lenovo (Beijing) Limited, Beijing (CN)

(72) Inventors: Ruifeng YAO, Beijing (CN); Xiang LI, Beijing (CN); Zhe WU, Beijing (CN)

(21) Appl. No.: 19/178,579

(22) Filed: Apr. 14, 2025

(30) Foreign Application Priority Data
Apr. 17, 2024 (CN) 202410465717.7

(51) Int. Cl. G06F 3/0484; G06F 3/01; G06F 3/14; G06F 3/16; G06F 9/451

(52) U.S. Cl. CPC G06F 3/0484; G06F 3/14; G06F 9/452; G06F 3/017; G06F 3/167

(57) ABSTRACT

A display control method includes: in response to a target event, controlling a target session item in a session window of a first application executing an interactive task to switch from a first display state to a second display state. The target session item is less identifiable in the second display state than in the first display state.

### RELATED APPLICATION(S)

This application claims priority to Chinese Patent Application No. 202410465717.7 filed with the National Intellectual Property Administration, PRC on Apr. 17, 2024, which is incorporated herein by reference in entirety.

### FIELD OF THE TECHNOLOGY

The present disclosure relates to, but is not limited to, the field of computer technology, and in particular to a display control method and devices.

### BACKGROUND

Computer applications may use conversation windows to facilitate searches and social dialogues. In public places, questions entered by users in the conversation window and the answers and content obtained by inquiries may be subject to privacy leakage. As the conversation progresses, the amount of text may accumulate on the display screen, making the display interface cluttered and inconvenient for users to quickly browse the information of interest.

How to improve the display method of the conversation content in a conversation window is therefore a topic of interest.

### SUMMARY

The present disclosure in some embodiments provides a display control method and device.

In one aspect, the present disclosure provides a display control method. The method includes: in response to a target event, controlling a target session item in a session window of a first application executing an interactive task to switch from a first display state to a second display state, where the target session item is less identifiable in the second display state than in the first display state.

In another aspect, the present disclosure provides a display control device. The display control device includes: a display switching module, for controlling a target session item in a session window of a first application executing an interactive task to switch from a first display state to a second display state in response to a target event, where the target session item is less identifiable in the second display state than in the first display state.

In yet another aspect, the present disclosure provides a display control device. The display control device includes: a memory storing computer program instructions; and a processor coupled to the memory and configured to execute the computer program instructions and perform: in response to a target event, controlling a target session item in a session window of a first application executing an interactive task to switch from a first display state to a second display state, where the target session item is less identifiable in the second display state than in the first display state.

General description and the detailed description below are explanatory, and do not limit the technical solution of the present disclosure.

### BRIEF DESCRIPTION OF THE DRAWINGS

The accompanying drawings herein are incorporated into the present disclosure and constitute a part of the present disclosure. These drawings illustrate embodiments consistent with the present disclosure and are employed together with the present disclosure to illustrate the technical solution of the present disclosure.

FIG. 1 is a schematic diagram of an implementation process of a display control method according to some embodiments of the present disclosure;

FIGS. 2A to 2C are schematic diagrams of an operation interface in a display control method according to some embodiments of the present disclosure;

FIGS. 3A to 3B are schematic diagrams of an operation interface in a display control method according to some embodiments of the present disclosure;

FIG. 4 is a schematic diagram of a composition structure of a display control device according to some embodiments of the present disclosure; and

FIG. 5 is a schematic diagram of a hardware entity of a computer device according to some embodiments of the present disclosure.

### DETAILED DESCRIPTION

To make clear the purpose, technical solution and advantages of the embodiments of the present disclosure, certain technical solution of the embodiments of the present disclosure is described in detail below in conjunction with the accompanying drawings. The following embodiments are used to illustrate the present disclosure, but are not used to limit the scope of the present disclosure.

Reference is made to “some embodiments” or “some embodiments”, which describe a subset of all possible embodiments, “some embodiments” or “some embodiments” may be the same subset or different subsets of possible embodiments and may be combined with each other without conflict.

Terms “first\second\third” are used to distinguish similar objects and do not necessarily represent a specific ordering of the objects. Terms “first\second\third” may be interchanged with a specific order or sequence where permitted, so that the embodiments of the present disclosure described herein may be implemented in an order other than that illustrated or described herein.

Unless otherwise mentioned, technical and scientific terms used herein have the same meaning as those commonly understood in the technical field. The terms used herein are for the purpose of describing the embodiments of the present disclosure and are not intended to limit the present disclosure.

In some applications, the function of deleting historical information allows users to delete sensitive or private information according to personal preferences, thereby achieving the effect of avoiding privacy leakage and reducing the content displayed on the display interface. However, this solution requires users to manually select and delete the information to be deleted, and the operation steps may be complicated; in addition, after the information is deleted, the deleted information may not be restored, causing users to have to choose between deleting information and protecting privacy. Therefore, this solution still may not provide users with a good user experience.

The present disclosure in some embodiments provides a display control method, which may be executed by a processor of a computer device. The computer device may refer to a server, a laptop, a tablet computer, a desktop computer, a smart TV, a set-top box, a mobile device (such as a mobile phone, a portable video player, a personal digital assistant, a dedicated messaging device, a portable gaming device) and other devices with display control capabilities.

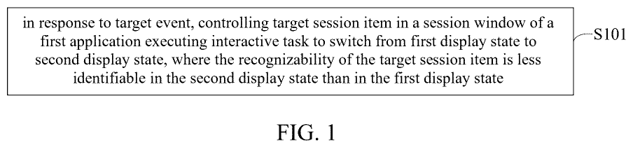

FIG. 1 is a schematic diagram of an implementation flow of a display control method provided by the present disclosure in some embodiments. As shown in FIG. 1, the method includes step S101:

Step S101, in response to a target event, controlling a target session item in a session window of a first application executing a current interactive task to switch from a current first display state to a second display state; where the target session item is less identifiable in the second display state than the in the first display state.

In some embodiments, the target event refers to an event that triggers a display state change of a session item in the session window.

In some embodiments, the target event may be a system default event or an event identified according to a user setting. In some embodiments, when being a system default event, the target event may include a user sliding a particular session item in a session window on a touch display screen with a single finger; when being an event identified by a user setting, the target event may be other operation modes set by the user, such as a gesture made by the user in a three-dimensional space.

In some embodiments, the target event may be an operation instruction issued by the user through a behavior, or it may be a state switch detected by the electronic device running the first application. In some embodiments, when the target event is an operation instruction issued by the user through a behavior, the target event may include the user's touch operation on the touch display screen of the electronic device, the user's voice operation instruction input through voice, and/or the character operation instruction input through the mouse and/or keyboard; when the target event is a state switch detected by the electronic device, the target event may include changes in the current time detected by the electronic device, changes in location, switching of the user of the electronic device, changes in the connection status of the electronic device and other devices, changes in the networking status of the electronic device (in some embodiments, switching to a network environment, or switching from an unconnected state to a connected state), and usage status switching (in some embodiments, switching from a personal use state to a shared state), or the like.

The first application refers to an application that may provide a conversation or search function for a user. In some embodiments, the first application includes a session window so that the user may conduct a social conversation or intelligent search based on the session window.

In some embodiments, the first application includes an application that may provide an instant messaging service.

In some embodiments, the first application includes a browser having a session window.

In some embodiments, the first application is an artificial intelligence agent (AI Agent), such as Lenovo Xiaotian agent or other intelligent assistant applications.

A session item (or session item) refers to a conversation bar corresponding to the interactive content displayed in the session window of the first application.

In some embodiments, the target session item may include a session item issued by a target user of the first application, a session item corresponding to the conversation content issued by a peer user who is having a conversation with the target user of the first application, or a session item corresponding to a search result generated based on search information issued by the target user of the first application.

The first display state refers to a state in which the target session item is fully displayed or partially displayed in the session window of the first application.

The second display state refers to a display state that is less recognizable in the session window of the first application than the first display state. In some embodiments, when the first display state represents a fully displayed state corresponding to the session item, the second display state represents a partially displayed state or a hidden state corresponding to the session item; in certain other embodiments, when the first display state represents a partially displayed state corresponding to the session item, the second display state represents a hidden state corresponding to the session item. In some embodiments, the session item as displayed in the second display state is shorter in length and/or fewer in words than the session item as displayed in the first display state.

In some embodiments, the target session item may be switched to the second display state by graffiti or mosaic processing of at least part of the target session content, so that the graffiti or mosaic processing covers a portion of the target session item to make the target session item appear shorter in length and/or fewer in words as displayed.

By switching the target session item from the first display state to the second display state, the identifiability of the target session item may be reduced, and the effect of hiding at least part of the session content in the target session item may be achieved.

In the display control method provided by the present disclosure, by responding to a target event, the target session item in the session window of the first application is controlled to switch from the first display state to the second display state, and the target session item is less identifiable in in the second display state than that in the first display state. When the target session item contains user privacy information, the at least part of the content in the target session item may be less identifiable through the target event, thereby avoiding leakage of the user's privacy information; in addition, when there are a large number of session items in the session window, the target session item may be less identifiable through the target event, in some embodiments, the target session item is hidden to reduce space consumption on the display screen, thereby making the interface of the session window more concise, and the user may better focus on the information of interest, thereby achieving the effect of improving the user experience.

In some embodiments, the display control method provided by the present disclosure further includes S102:

Step S102, determining a target session item from the session window of the first application based on the target event.

In some embodiments, the session window of the first application contains at least one session item, and the target session item may be determined from the at least one session item based on the type, content or action mode of the target event.

In some embodiments, determining the target session item from the session window of the first application based on the target event may be implemented via one or more of steps S1021 to S1024:

Step S1021, in response to obtaining a target gesture operation acting on the session window, determining at least one session item identified by the target gesture operation as the target session item.

In some embodiments, the target event includes a target gesture operation acting on the session window of the first application.

In some embodiments, the electronic device running the first application includes a touch display screen.

In some embodiments, the target gesture operation may include a click operation performed by the user within the session window of the first application; in some embodiments, the current user uses a single finger to perform a click operation within the session window of the first application, or uses two or more fingers to perform a click operation within the session window of the first application; in some embodiments, the user single-clicks or double-clicks within the session window of the first application, or the like.

In some embodiments, the target gesture operation may include a sliding operation performed by the user in the session window of the first application; in some embodiments, the sliding operation is a sliding operation performed by the user in a certain direction in the session window of the first application using a single finger, or a sliding operation performed by the user in a certain direction in the session window of the first application using two or more fingers, or the like.

In some embodiments, the target gesture operation may include a long press operation performed by the user in the session window of the first application; in some embodiments, the long press operation is a long press operation performed by the user at a certain position in the session window of the first application.

In some embodiments, the target gesture operation may include a sliding operation performed by a user using a mouse control key within the session window of the first application; in some embodiments, the user long presses a certain position within the first application window using the left button of the mouse and slides the mouse along a certain direction.

In response to the target gesture operation, at least one session item identified by the target gesture operation is identified as a target session item.

In some embodiments, the at least one session item identified by the target gesture operation may include a session item corresponding to the target gesture operation. In some embodiments, when the target gesture operation includes a sliding operation in a specified direction in a session window of a first application using a single finger of the user, and the touch position of the target gesture operation on the touch display screen of the electronic device corresponds to a session item in the session window of the first application, a session item corresponding to the target gesture operation is identified as the target session item.

In some embodiments, at least one session item identified by the target gesture operation may include a session item corresponding to the target gesture operation and a session item related to the corresponding session item. In some embodiments, when the target gesture operation includes a sliding operation in a specified direction in a session window of a first application performed by a user using a single finger, and the touch position of the target gesture operation on the touch display screen of the electronic device corresponds to a session item in the session window of the first application, a session item corresponding to the target gesture operation and session entries belonging to the same session party as the session item (in some embodiments, both belonging to the session item of the current user of the first application, or both belonging to the session item of the opposite session user of the current user) are determined as target session entries. For another example, when the target gesture operation includes a sliding operation in a specified direction in a session window of a first application performed by a user using a single finger, and the touch position of the target gesture operation on the touch display screen of the electronic device corresponds to a session item in the session window of the first application, a session item corresponding to the target gesture operation and session entries associated with the content of the session item (in some embodiments, the session item where the search result of the session item corresponding to the target gesture operation is located) are determined as target session entries.

In some embodiments, when the target gesture operation is a gesture operation performed by the current user using a single finger within the session window of the first application, a session item corresponding to the target gesture operation is identified as the target session item; when the target gesture operation is a gesture operation performed by the current user using two or more fingers within the session window of the first application, a session item corresponding to the target gesture operation and other session entries related to the session item are determined as the target session entries.

In some embodiments, at least one session item identified by the target gesture operation is identified as the target session item, that is, the above step S1021 may be implemented as the following steps S1025 to S1026:

Step S1025, in response to obtaining a track operation acting on the first session item in the session window, the first session item is identified as the target session item.

In some embodiments, the first session item may be session information input by the user of the electronic device, or may be session information fed back by the peer end interacting with the user of the electronic device.

In some embodiments, the first session item may be social conversation information, or a search question asked by a user of the electronic device to an intelligent search engine, or a search result returned by the intelligent search engine.

In some embodiments, a track operation acting on the first session item is a gesture track input by the user of the electronic device for the first session item.

In some embodiments, the track operation applied to the first session item may be a touch operation or a press operation performed by a user on a touch-screen display area corresponding to the first session item, or may be a mouse operation performed by a user using a mouse device along a particular track on a display area corresponding to the first session item.

In some embodiments, the track operation acting on the first session item may be a sliding operation from left to right, from right to left, from top to bottom, or from bottom to top, etc. In some embodiments, the sliding operation may be a straight sliding operation or an arc sliding operation.

Step S1026, in response to obtaining at least two track operations acting on the second session item in the session window, the second session item and at least one third session item associated with the second session item are determined as the target session item.

In some embodiments, at least two track operations refer to operations including two or more tracks performed by the user in the session window of the first application.

In some embodiments, at least two track operations may include track operations triggered simultaneously by the user using two or more fingers to act on the session window of the first application. In some embodiments, the user uses two fingers to perform a sliding operation from left to right on the second session item at the same time.

In some embodiments, the at least two track operations may include two track operations performed by a user using one finger in the session window of the first application with a short interval. In some embodiments, the user uses one finger to perform two sliding operations from left to right on the second session item, and the interval between the two sliding operations is less than the time threshold.

In some embodiments, the operation positions of the at least two track operations correspond to one second session item respectively, that is, the corresponding second session items are determined respectively using the at least two track operations. In some embodiments, the user uses one finger to perform sliding operations from left to right on two second session items respectively, and the interval between the two sliding operations is less than the time threshold.

In some embodiments, at least one third session item associated with the second session item refers to a session item that has content relevance to the second session item. In some embodiments, a session item whose content belongs to the same conversation topic as the second session item is used as the third session item; for another example, a session item that contains the same sensitive words or keywords as the second session item is used as the third session item. In this way, by using the session item that has content relevance to the second session item as the target session item together with the second session item, the display status of all information related to user privacy may be adjusted, thereby achieving a better effect of protecting user privacy.

Considering that a session item that is adjacent to the second session item specified by the user in position or generation time may allow people to speculate the content of the second session item, in some embodiments, at least one third session item associated with the second session item refers to a session item that is related to the second session item in position or time. In some embodiments, a session item that is adjacent to the display position of the second session item in the session window is taken as the third session item; for another example, a session item that is adjacent to the generation time of the second session item in the session window is taken as the third session item.

Step S1022, in response to obtaining a voice input operation acting on the session window, determining at least one session item identified by the voice input operation as the target session item.

In some embodiments, the target event includes a voice input operation acting on the session window of the first application.

In some embodiments, the electronic device running the first application includes a voice collection device, and the first application has a function option corresponding to the voice input function. When the user chooses to use the voice input method to send an operation instruction to the first application, the first application may call the voice collection device of the electronic device, and use the voice collection device to obtain the user's voice information, and then identify the operation instruction contained in the voice information.

In some embodiments, when the operation instruction corresponding to the voice input operation includes a session item, the session item is identified as a target session item.

In some embodiments, when the operation instruction corresponding to the voice input operation includes a session item, the session item and other conversation entries related to the session item (in some embodiments, other conversation entries belonging to the same conversation party as the session item, or other conversation entries belonging to the same conversation topic as the session item) are identified as target session items.

In some embodiments, when the operation instruction corresponding to the voice input operation includes multiple session items, the multiple session items are identified as target session items.

In some embodiments, semantic recognition is performed on the operation instruction corresponding to the voice input operation to determine at least one target semantic information, and the session items related to each target semantic information in the session window are determined as target session items. In some embodiments, semantic recognition is performed on the operation instruction corresponding to the voice input operation to determine that the operation instruction includes semantic information related to “Panda Huahua”, and session items including semantic information related to “Panda Huahua” are determined as target session items.

Step S1023, in response to obtaining a character string input operation acting on the session window, determining at least one session item identified by the character string input operation as the target session item.

In some embodiments, the target event includes a character string input operation acting on the session window of the first application.

In some embodiments, the session window of the first application includes a text input window, so that the user may input character string information through the text input window and perform conversation interaction based on the character string information.

In some embodiments, text recognition is performed on the string input by the string input operation to determine at least one position information corresponding to the input string, and a target session item is identified based on the at least one position information.

In some embodiments, when the at least one position information corresponding to the input string points to a session item, the session item is identified as the target session item.

In some embodiments, when at least one location information corresponding to the input string points to a session item, the session item and other session entries related to the session item (in some embodiments, other session entries having content relevance, location relevance, or generation time relevance to the session item) are identified as target session items.

In some embodiments, when at least one location information corresponding to the input string points to multiple session entries, the multiple session entries are identified as target session items.

In some embodiments, the string input by the string input operation is identified to determine at least one keyword, and the session items containing the keyword in the session window are determined as target session items. In some embodiments, when the user enters “hide the session containing Panda Huahua” in the text input window, “Panda Huahua” may be identified as a keyword, and the session items containing “Panda Huahua” are identified as target session items.

In some embodiments, a semantic analysis is performed on the string input by the string input operation to determine semantic information, and the session item related to the semantic information in the session window is identified as the target session item. In some embodiments, semantic recognition is performed on the string input by the string input operation, and it is determined that the string contains semantic information related to “search Panda Huahua”, the session item containing the semantic information related to “search Panda Huahua” is identified as the target session item.

Step S1024, in response to obtaining the target reference data, determining at least one session item in the session window including the target word or representing the target content as the target session item.

In some embodiments, the target event includes obtaining the target reference data.

In some embodiments, the target reference data refers to state data related to the electronic device running the first application, and the state data may trigger the target session item to switch from the first display state to the second display state.

In some embodiments, the target reference data may include current time information, information about changes in the usage location of the electronic device running the first application, information about changes in the user of the electronic device, information about changes in the connection status of the electronic device with other devices, information about changes in the networking status of the electronic device, information about changes in the usage status of the electronic device, and the like.

Target words and target content refer to words or content that involve user privacy information or user-defined privacy conditions. In some embodiments, words or content related to diseases may involve the user's personal physical condition information, which is the user's privacy information, and therefore belongs to target words or target content; in some embodiments, words or content related to a work project identified by the user may involve the confidential information of the work project, and therefore belongs to target words or target content.

In some embodiments, in response to obtaining target reference data, a target word (such as a keyword) is identified; based on the identified keyword, a keyword matching algorithm is used to determine at least one session item in the session window that contains the keyword, and the determined at least one session item is identified as the target session item.

In some embodiments, in response to obtaining target reference data, a target content is identified; based on the target content, a semantic extraction algorithm is used to determine at least one session item whose semantic information of each session item in the session window corresponds to the semantic information of the target content, and the determined at least one session item is identified as the target session item.

In some embodiments, in response to obtaining the target reference data, the target content is identified; using a feature extraction algorithm, features are extracted from the determined target content and each session item in the session window, and based on the similarity of the extracted features, at least one session item with a similarity higher than a similarity threshold is determined, and the determined at least one session item is identified as the target session item.

In some embodiments, in response to obtaining the target reference data, at least one session item in the session window including the target word or representing the target content is identified as the target session item. Step S1024 may be implemented as steps S1027 to S10212:

Step S1027, in response to entering the target time period, determining at least one session item in the session window that includes the target word or represents the target content as the target session item.

In some embodiments, the target reference data includes the current time entering the target time period.

In some embodiments, the target time period may include a screen sharing time period, a work time period, or a meeting time period corresponding to the electronic device. In response to entering the target time period, at least one session item in the session window containing a target word or representing a target content is identified as a target session item, and the display state of the target session item is switched to a second display state with target session item being less identifiable, thereby hiding user privacy information or information unrelated to the affairs processed in the current time period during screen sharing, work, or meeting time, thereby achieving the purpose of protecting user personal privacy and improving work efficiency, and improving user experience.

Step S1028, in response to the electronic device entering the target space area, determining at least one session item including the target word or representing the target content in the session window as the target session item.

In some embodiments, the target reference data includes the electronic device entering the target space area.

In some embodiments, the target space area includes a public area, such as a living room, a conference room, a library, or the like.

In some embodiments, considering that after the user enters a public space with poor privacy from a personal workspace with good privacy, the conversation content in the session window may be seen by strangers, therefore, in order to protect the user's privacy information, at least one session item in the session window that includes words related to the user's privacy information or represents the user's privacy content is identified as the target session item.

Step S1029, in response to a change of the user of the electronic device, at least one session item in the session window that includes a target word or represents the target content is identified as the target session item.

In some embodiments, the target reference data includes changes of the user of the electronic device.

In some embodiments, the change of the user refers to a change of the user who inputs the conversation content in the session window of the first application.

In some embodiments, the user image may be captured by an image capture device installed on the electronic device, and the information about the user change may be determined by image recognition; the information about the user change may also be determined by the change in the user's operating habits on the electronic device.

When it is determined that the user of the electronic device has changed, in order to protect the personal privacy information of the previous user from being seen by the next user, at least one session item in the session window including words related to the privacy information of the previous user or representing the privacy content of the previous user is identified as the target session item.

Step S10210, in response to a change in the connection state between the electronic device and the first target device, at least one session item in the session window including the target word or representing the target content is identified as the target session item.

In some embodiments, the target reference data includes a change in the connection state between the electronic device and the first target device.

In some embodiments, the first target device refers to a terminal device that establishes a connection with the electronic device. In some embodiments, the first target device may be a projection device, a mobile device, or the like.

The connection state between the electronic device and the first target device changes, when the electronic device establishes a connection with the first target device or disconnects from the first target device.

When the electronic device establishes a connection with the first target device, in order to prevent the user privacy information displayed in the session window of the first application from being seen by the user of the first target device, at least one session item in the session window including words related to the user privacy information or representing the user privacy content is identified as a target session item, to further switch the display state of the target session item to a display state with lower identifiability, to better protect the user privacy.

In some embodiments, the first target device refers to a network device that provides network services to the electronic device, such as a gateway device, or the like.

The connection status between the electronic device and the first target device changes, when the electronic device joins the network environment provided by the network device (the electronic device enters the networking state), or the electronic device leaves the network environment provided by the network device (the electronic device switches to other network environments, or switches to local use state).

After the electronic device joins the network environment provided by the first target device, in order to prevent the user privacy information displayed in the session window of the first application from being seen by other users in the same network environment, at least one session item in the session window that includes words related to user privacy or represents user privacy content is identified as a target session item, to further switch the display state of the target session item to a display state with lower identifiability, such as the second display state, thereby achieving the purpose of better protecting the user's personal privacy.

Step S10211, in response to a change in the usage mode of the electronic device, at least one session item including the target word or representing the target content in the session window is identified as the target session item.

In some embodiments, the target reference data includes a change in the usage mode of the electronic device.

In some embodiments, the usage mode of the electronic device includes a personal mode, a shared mode, a family mode, a youth mode, and the like.

In some embodiments, the usage mode of the electronic device changes, which may be switched from a personal mode to a shared mode or a family mode. The privacy of the electronic device is reduced in the shared mode and the family mode, when the usage mode change is detected, at least one session item in the session window that includes words related to user privacy or represents user privacy content is identified as a target session item, to further switch the display state of the target session item to a display state with lower identifiability, such as the second display state, to achieve the purpose of better protecting the user's personal privacy.

In some embodiments, the usage mode of the electronic device changes, and may also be switched from a personal mode to a youth mode. To protect the privacy information of the previous user and protect the healthy Internet access of teenagers, at least one session item in the session window that includes the target word or represents the target content is identified as a target session item.

Step S10212, in response to obtaining an operation of sharing the session window with a second target device, determining at least one session item in the session window including a target word or representing a target content as the target session item.

In some embodiments, the target reference data includes an operation of sharing the session window of the first application with the second target device.

The second target device may be any type of electronic device having a display function.

In some embodiments, sharing the session window with the second target device may include sharing the session window with the second target device by screen sharing or window sharing, and may also include taking a screenshot of the session window and sharing the screenshot with the second target device.

When the session window is shared with the second target device, in order to prevent the user privacy information displayed in the session window from being seen by the user of the second target device, at least one session item in the session window that includes words related to user privacy or represents user privacy content is identified as a target session item, to further switch the display state of the target session item to a display state with lower identifiability, such as the second display state, thereby achieving the purpose of better protecting the user's personal privacy.

In response to a target gesture operation, a voice input operation, a string input operation, and/or obtaining various types of target reference data acting on a session window, at least one session item is identified as a target session item, to adapt to different target events, switch the display status of session items involving user privacy information in the session window, or hide session items of a certain type, to make the interface of the session window more concise and allow users to focus on the conversation content of interest.

In some embodiments, the target session item in the session window of the first application executing the current interactive task is controlled to switch from the first display state to the second display state. Step S101 may be implemented as one or more of steps S1011 to S1013:

Step S1011, controlling the first session item in the session window to switch from the full display state to the hidden state or the partial display state.

In some embodiments, the first display state includes a full display state; the second display state includes a hidden state and/or a partial display state.

The full display state means that all the conversation contents in the first session item are displayed in the session window.

The hidden state means that the conversation contents in the first session item are hidden in the session window.

The partial display state means that part of the conversation contents in the first session item are graffitied or mosaiced to achieve the effect of desensitizing or hiding personal privacy information; or, part of the conversation contents in the first session item are folded and displayed to reduce the area of the display area where the first session item is located.

By switching the first session item from the fully displayed state to a hidden state or a partially displayed state, the user privacy information contained in the first session item may be hidden, thereby reducing the risk of user privacy leakage; in addition, switching the first session item to a hidden state or a partially displayed state may reduce the area of the display region where the first session item is located, thereby making the session window interface concise and allowing users to better focus on the conversation content of interest.

Step S1012, controlling the second session item in the session window to switch from the first display parameter to the second display parameter.

In some embodiments, the display parameter refers to the display mode of the session item in the session window. In some embodiments, the display parameter may include the transparency, font size, background color, display size, or the like of the session item.

In some embodiments, controlling the second session item in the session window to switch from the first display parameter to the second display parameter, that is, step S1012 may be implemented as one or more of steps S1014 to S1017:

Step S1014, controlling the second session item to switch from being displayed in the first display area to being displayed as a symbol mark without text information or image information.

In some embodiments, the display state of the second session item in the first display area is fully displayed, or partially displayed (in some embodiments, the conversation content in the second session item is folded and displayed).

The symbol mark without text information or image information means that the symbol mark is used in the session window to indicate the hidden position of the second session item, and no conversation content in the second session item is displayed.

In some embodiments, the symbol mark may be any symbol, such as a circular symbol, a square symbol, or the like.

The second session item may be hidden by or through the symbol mark, and the user may use the symbol mark to switch the second session item from the second display state to the first display state.

Step S1015, controlling the display size of the second session item to switch from the first display size to the second display size, and the second display size is smaller than the first display size.

In some embodiments, under the first display size, the second session item is visible or identifiable, and the user may view the conversation content in the second session item; under the second display size, the second session item is less visible or identifiable, and the user may not readily view or confirm the conversation content in the second session item.

Step S1016, controlling the display transparency of at least part of the content in the second session item to switch from the first transparency to the second transparency, and the second transparency is greater than the first transparency.

In some embodiments, at least part of the content in the second session item includes at least the content related to the user's personal privacy contained in the second session item.

In some embodiments, the first transparency is relatively small, so that the conversation content in the second session item is more visible or recognizable; the second transparency is relatively large, so that the conversation content in the second session item is less visible or recognizable.

By adjusting the transparency of at least part of the content in the second session item, the effect of protecting user privacy may be achieved.

Step S1017, masking at least part of the content in the second session item.

In some embodiments, at least part of the content in the second session item includes content related to user privacy contained in the second session item.

In some embodiments, the masking process may include graffiti or mosaic processing of at least part of the content in the second session item so that the content related to user privacy contained in the second session item is masked or hidden.

By switching the second session item from being of the first display parameter to the second display parameter, the visibility or identifiability of the second session item may be reduced, thereby achieving the effect of protecting user privacy.

Step S1013: Controlling the second session item and at least one third session item associated with the session window to switch from the first display state to the second display state.

In some embodiments, by switching the second session item and at least one associated third session item from the first display state to the second display state, the display state of multiple session items in the session window may be switched at the same time, thereby avoiding the problem of complicated operation caused by the user switching one by one; in addition, by switching the display state of multiple session items, in some embodiments, switching the session item with the content of a question sent by the user of the first application from a fully displayed state to a hidden state, and only displaying the session item with the content of the answer to the above question, the session window interface may be made more concise, and the user may focus on the session item with the content of the answer.

In some embodiments, the display control method provided by the present disclosure includes one or more of steps S103 to S105:

Step S103: after controlling the second session item in the session window and at least one associated third session item to switch to the corresponding symbol mark, only the symbol mark of the second session item is displayed, a symbol mark set is displayed at the location of the second session item, or the symbol mark of the third session item is associated with the folded space or drop-down box of the symbol mark of the second session item.

In some embodiments, the second session item and at least one associated third session item are switched to corresponding symbol mark, that is, the multiple conversation entries are switched from the first display state to a state where only corresponding symbol marks are displayed.

In some embodiments, only the symbol mark of the second session item is displayed, that is, the symbol mark corresponding to any third session item is no longer displayed in the session window, thereby further simplifying the session window interface.

In some embodiments, a symbol mark set is displayed at the location of the second session item, which may prompt the user that the symbol mark set corresponds to multiple conversation entries.

In addition, the symbol mark of the third session item may also be associated with the folding space or drop-down box of the symbol mark of the second session item, so that while the session window interface is neat, the user may also selectively display the specified session item through the folding space or drop-down box.

Step S104: Based on the attribute information and/or evaluation information of the target session item, corresponding privacy processing is performed on the target session item to switch target session item to the second display state.

In some embodiments, the attribute information of the session item may include type information of the session content in the session item. In some embodiments, the session content includes picture type, text type, audio type, video type, or the like.

In some embodiments, the evaluation information of the session item may include privacy level information of the session content in the session item. In some embodiments, the privacy information involved in the session content may be divided into multiple levels such as private, confidential, and top secret according to default rules or user-designed rules.

In some embodiments, the evaluation information of the session item includes the permission information of different users to use the session content in the session item. In some embodiments, different users have different rights to know about the information involved in the same work project. When different users use the electronic device, the session item containing the project information is processed for privacy accordingly.

In some embodiments, the privacy processing may be switching the font size of the target session item, switching the transparency of the session item, graffiti or mosaic processing, or selecting which part of the content in the target session item to process for privacy, or the like.

In some embodiments, when the attribute information of the target session item indicates that the session content in the target session item is of text type, the target session item may be graffitied or mosaiced; when the attribute information of the target session item indicates that the session content in the target session item is of picture type, the target session item may be subjected to transparency switching processing; when the attribute information of the target session item indicates that the session content in the target session item is of video or audio type, the target session item may be switched to a corresponding symbol mark; and so on.

Step S105, in response to obtaining the target input operation, switching the target session item from the second display state back to the first display state.

In some embodiments, the target input operation refers to the operation of switching the target session item from the second display state back to the first display state.

In some embodiments, the target input operation may include a gesture operation corresponding to the target gesture operation in the target event. In some embodiments, the user performs a single click or double click operation on the target session item in the second display state with a finger.

In some embodiments, the target input operation may include a voice operation, that is, obtaining the user's voice information through the audio acquisition device of the electronic device, and switching the target session item back from the second display state to the first display state based on the voice information.

In some embodiments, the target input operation may include a single click, double click, or right key selection recovery operation input by the user through a mouse device.

In some embodiments, the target input operation may include triggering a shortcut key on a keyboard device; the shortcut key is used to switch the target session item in the session window back from the second display state to the first display state.

In some embodiments, in response to obtaining a target input operation, the target session item is switched back from the second display state to the first display state, that is, step S105 may be implemented as one or more of steps S1051 to S1053:

Step S1051, in response to obtaining a first track operation acting on the first session item in the session window, controlling the first session item to switch back from a hidden state or a partially displayed state to a fully displayed state.

In some embodiments, the target input operation includes a first track operation acting on the first session item.

The first track operation may be a gesture operation acting on the first session item, or may be a mouse operation performed by a user on the first session item through a mouse device.

Step S1052, in response to obtaining a click operation of a symbol mark acting on a second session item in the session window, controlling the symbol mark to switch back to fully display the second session item.

In some embodiments, the target input operation includes a click operation on the symbol mark of the second session item.

The click operation may be a gesture operation of a user's finger on the second session item, or a mouse click operation of a user on the second session item through a mouse device.

Step S1053, in response to obtaining a trigger operation of a key combination acting on an electronic device or obtaining a target voice input, controlling the target symbol mark to switch back to a state of displaying the target session item.

In some embodiments, the target input operation includes the trigger operation on a key combination or the voice input operation.

Key combination refers to the function key combination set by default or set by the user for switching the display status of the target session item.

Voice input is a process where the user's voice information is obtained by the audio acquisition device of the electronic device, and the control instructions in the user's voice information are determined by the voice recognition algorithm.

By obtaining the trigger operation of the key combination or obtaining the target voice input, the target symbol mark may be controlled to switch back to the state of displaying the target session item.

In some embodiments, through the first track operation, click operation, key combination trigger operation, or voice input, the session item may be switched back from the hidden state, partial display state or symbol mark state to the display state, so that the user may re-view the conversation content of the hidden session item, and simple operation and easy implementation are hence delivered.

In some embodiments, the target session item in the session window of the first application executing the current interactive task is controlled to switch from the first display state to the second display state, that is, step S101 may be implemented as one or more of steps S1018 to S10110:

Step S1018, in response to obtaining a second track operation acting on the first session item in the session window, control the first session item to switch from the full display state to a hidden state or a partial display state.

In some embodiments, the second track operation may be a gesture operation on the first session item, or a mouse operation performed by the user on the first session item through a mouse device.

In some embodiments, in response to the second track operation, the first session item is switched from a fully displayed state to a hidden state or a partially displayed state, thereby hiding the user privacy information in the first session item to achieve the purpose of protecting user privacy.

Step S1019, in response to obtaining at least two track operations acting on the second session item in the session window, controlling the second session item and at least one associated third session item (the third session item associated with the second session item) to switch from a fully displayed state to a hidden state or a partially displayed state.

In some embodiments, the at least two track operations may be at least two gesture operations acting on the second session item, or may be a mouse operation including at least two tracks performed by a user on the second session item through a mouse device.

In some embodiments, the at least two track operations may include track operations triggered simultaneously or concurrently by the user using two or more fingers in the session window of the first application, or two track operations performed by the user using one finger in the session window of the first application at an interval.

In some embodiments, additional description of the at least two track operations and the implementation method of determining at least one third session item associated with the second session item, may be found in reference to the description of step S1026, which is not repeated here in favor of brevity.

In some embodiments, switching the second session item and at least one third session item associated with the second session item from a fully displayed state to a hidden state or a partially displayed state may include switching the second session item and at least one third session item from a fully displayed state to corresponding symbol marks, and may also include switching display parameters, performing graffiti or mosaic processing, or folding display on the content containing privacy information in the second session item and each third session item.

Step S10110, in response to obtaining an operation of sharing the session window with a third target device, controlling at least one fourth session item including the target word and/or at least one fifth session item representing the target content in the session window to switch from a fully displayed state to a hidden state or a partially displayed state.

In some embodiments, the third target device may be any type of electronic device with a display function.

In some embodiments, in response to the operation of sharing the session window to the third target device, additional description of the implementation method of determining at least one fourth session item including the target word and/or at least one fifth session item representing the target content in the session window may be found in reference to the description of step S1022, which is not repeated here in favor of brevity.

In some embodiments, switching at least one fourth session item and/or at least one fifth session item from a fully displayed state to a hidden state or a partially displayed state may include switching at least one fourth session item and/or at least one fifth session item from a fully displayed state to a corresponding symbolic identification, and may also include switching display parameters, performing graffiti or mosaic processing, or folding display on the content containing privacy information in each fourth session item and/or each fifth session item.

The display control method provided by some embodiments of the present disclosure switches the display status of the session item containing the user's privacy information or the session item identified by the user, thereby reducing or avoiding the risk of privacy leakage, especially when using the electronic device in a public place or sharing the display content of the electronic device with others, to protect the user's privacy; in addition, by hiding, partially hiding or switching the display parameters of the session item, the interface of the session window may be made more concise, so that the user may focus on the current session or future session, or focus on reading the content of a certain type of session without being disturbed by other session content; in addition, the present disclosure in some embodiments allows the user to switch the display status of the target session item by using a variety of gesture operations, voice operations, string input operations or mouse device operations, or the like. These operation methods are all natural and intuitive user interaction methods, so that the user does not need to perform complex settings or deletion operations, which greatly simplifies the operation process, thereby providing a good user experience.

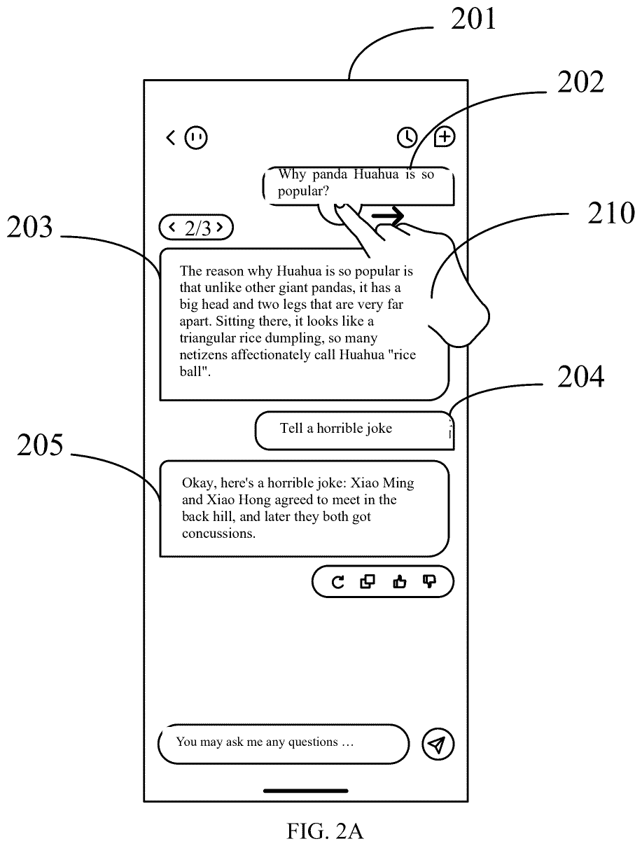

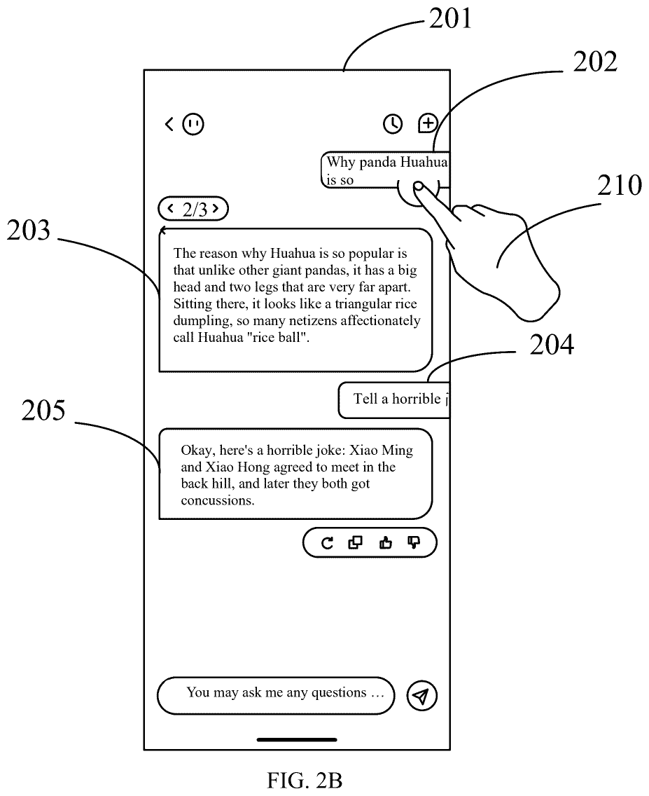

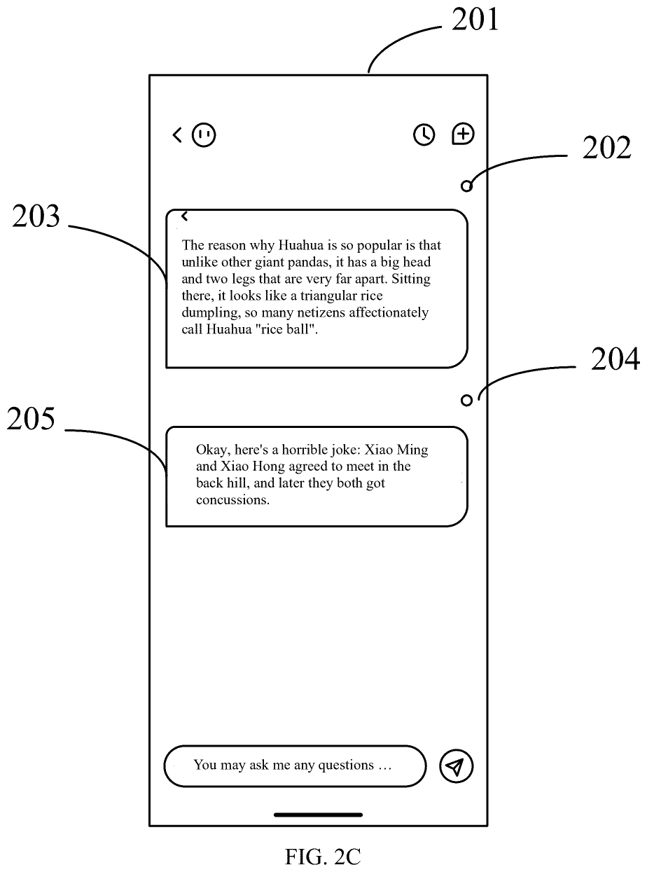

A display control method provided by some embodiments of the present disclosure is described in conjunction with FIG. 2A, FIG. 2B, and FIG. 2C.

As shown in FIG. 2A, FIG. 2B, and FIG. 2C, the first application includes a session window 201, and session items 202, 203, 204 and 205 are displayed in the session window 201, where session items 202 and 204 are conversation entries sent by the user, and session items 203 and 205 are search results returned by the smart search application according to the question raised by the user.

In FIG. 2A, the user uses a single finger of the hand 210 to act on the session item 202 and the finger performs a sliding from left to right.

In response to the user's sliding gesture, the session items 202 and 204 issued by the user gradually move to the right side of the session window 201 and a portion of the session window 201 is hidden, as shown in FIG. 2B.

When the user's finger slides to the rightmost side of the session window 201, the session items 202 and 204 are both displayed as circular symbol marks, as shown in FIG. 2C.

By sliding a single finger to the right, the session items issued by the user are hidden as symbol marks, thereby reducing space consumption and making the session window 201 more concise, and the user may focus on reading the session items 203 and 204 related to the search results.

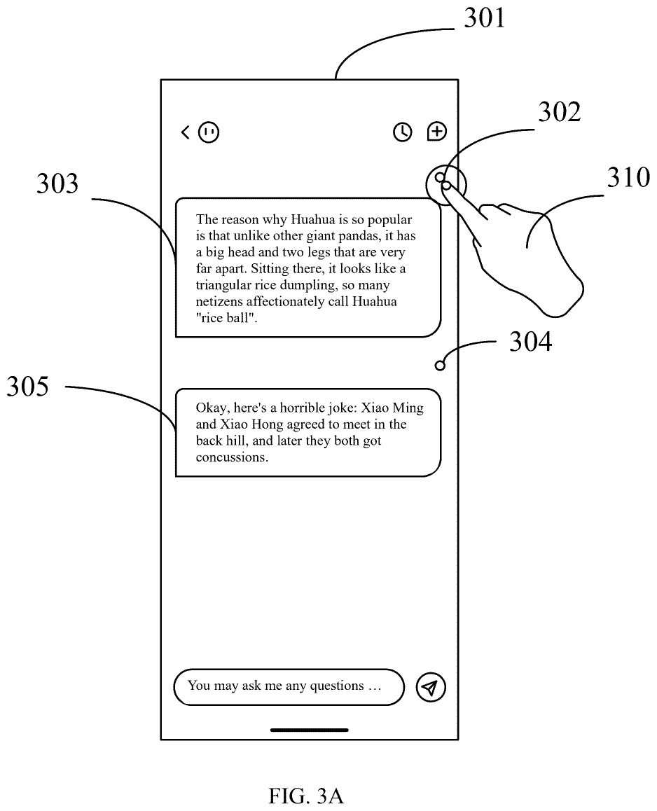

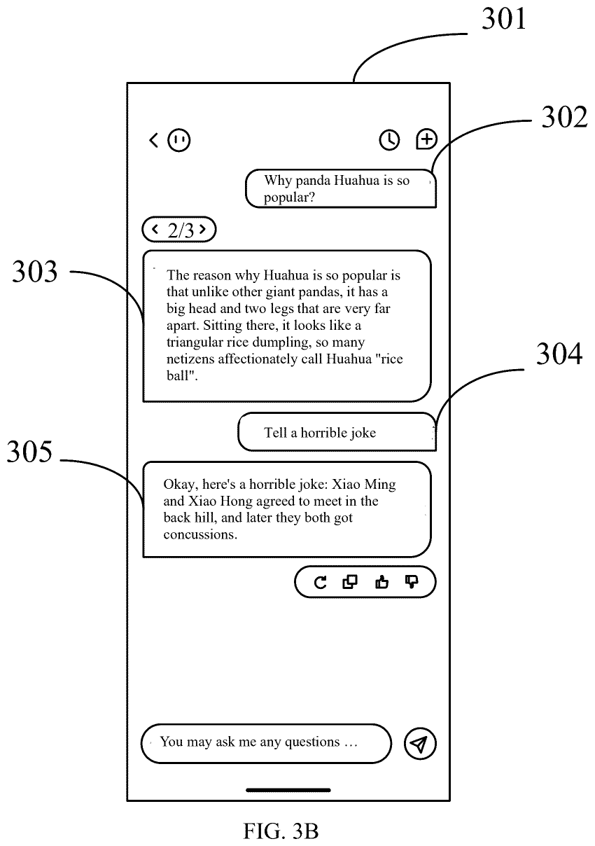

A display control method provided by some embodiments of the present disclosure is described in conjunction with FIG. 3A and FIG. 3B.

As shown in FIG. 3A and FIG. 3B, the first application includes a session window 301, and session items 302, 303, 304, and 305 are displayed in the session window 301, where session items 302 and 304 are conversation entries sent by the user, and session items 303 and 305 are search results returned by the smart search application according to the question raised by the user.

In FIG. 3A, the user uses a single finger of the hand 310 to act on the symbol mark corresponding to the session item 302, and starts to slide from right to left.

In response to the user's sliding gesture, the session items 302 and 304 issued by the user gradually turn to the left side of the session window 301, and display the conversation content, as shown in FIG. 3B.

By sliding leftward with a single finger, the conversation entries issued by the user are switched from a hidden state to a displayed state, so that the user may review the questions raised.

Embodiments of the present disclosure provides a display control device, which includes units and the modules included in the units, which may be implemented by a processor in a computer device; the device may also be implemented by a specific logic circuit; in the implementation process, the processor may be a central processing unit (CPU), a microprocessor (MPU), a digital signal processor (DSP) or a field programmable gate array (FPGA), or the like.

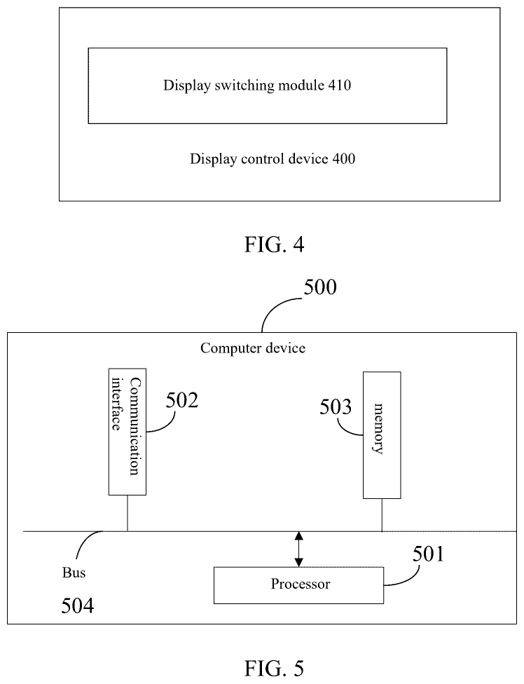

FIG. 4 is a schematic diagram of the composition structure of a display control device provided by some embodiments of the present disclosure. As shown in FIG. 4, the display control device 400 includes: a display switching module 410, where:

The display switching module 410 is used to control the target session item in the session window of the first application executing the current interactive task to switch from the first display state to the second display state in response to the target event;

The target session item is less recognizable in the second display state than in the first display state.

In some embodiments, the device 400 includes:

A determination module 420, configured to determine the target session item from the session window of the first application based on the target event;

The determination module 420 includes one or more of the following modules:

The first determination module 421 is used to determine at least one session item identified by the target gesture operation as the target session item in response to obtaining the target gesture operation acting on the session window;

The second determination module 422 is used to determine at least one session item identified by the voice input operation as the target session item in response to obtaining the voice input operation acting on the session window;

The third determination module 423 is used to determine at least one session item identified by the string input operation as the target session item in response to obtaining the string input operation acting on the session window;

The fourth determination module 424 is used to determine at least one session item including the target word or representing the target content in the session window as the target session item in response to obtaining the target reference data.

In some embodiments, the first determination module 421 is used to perform one or both of:

In response to obtaining a track operation acting on a first session item in the session window, determining the first session item as the target session item;

In response to obtaining at least two track operations acting on a second session item in the session window, determining the second session item and at least one third session item associated with the second session item as the target session item.

In some embodiments, the fourth determination module 424 is used to perform at least one of the following:

In response to entering the target time period, determining at least one session item in the session window that includes the target word or represents the target content as the target session item;

In response to the electronic device entering the target space area, determining at least one session item in the session window that includes the target word or represents the target content as the target session item;

In response to a change in the user of the electronic device, at least one session item in the session window including the target word or representing the target content is identified as the target session item;

In response to a change in the connection state between the electronic device and the first target device, at least one session item in the session window including the target word or representing the target content is identified as the target session item;

In response to a change in the usage mode of the electronic device, at least one session item in the session window including the target word or representing the target content is identified as the target session item;

In response to obtaining an operation of sharing the session window with a second target device, at least one session item in the session window including a target word or representing a target content is identified as the target session item;

Wherein, the electronic device is a device running the first application.

In some embodiments, the display switching module 410 includes at least one of the following modules:

The first switching module 411 is used to control the first session item in the session window to switch from a current fully displayed state to a hidden state or a partially displayed state;

The second switching module 412 is used to control the second session item in the session window to switch from the current first display parameter to the second display parameter;

The third switching module 413 is used to control the second session item in the session window and at least one third session item associated with it to switch from the current first display state to the second display state.

In some embodiments, the second switching module 412 is used to perform at least one of the following:

Controlling the second session item to switch from being displayed in the first display area to being displayed as a symbol mark without text information or image information;

Controlling the display size of the second session item to switch from the first display size to the second display size, wherein the second display size is smaller than the first display size;

Controlling the display transparency of at least part of the content in the second session item to switch from the first transparency to the second transparency, the second transparency being greater than the first transparency;

Masking processing is performed on at least part of the content in the second session item.

In some embodiments, the display switching module 410 further includes at least one of the following modules:

A fourth switching module 414 is used to control the second session item and at least one third session item associated with the session item in the session window to switch to corresponding symbol marks, display only the symbol mark of the second session item, display a symbol mark set at the location of the second session item, or associate the symbol mark of the third session item with the folded space or drop-down box of the symbol mark of the second session item;

The fifth switching module 415 is used to perform corresponding privacy processing on the target session item based on its attribute information and/or evaluation information to switch it to the second display state;

The sixth switching module 416 is used to switch the target session item back from the second display state to the first display state in response to obtaining the target input operation.

In some embodiments, the sixth switching module 416 is used to perform at least one of the following:

In response to obtaining a first track operation acting on a first session item in the session window, controlling the first session item to switch back from a hidden state or a partially displayed state to a fully displayed state;

In response to obtaining a click operation of a symbol mark acting on a second session item in the session window, controlling the symbol mark to switch back to fully displaying the second session item;

In response to obtaining a trigger operation of a key combination acting on an electronic device or obtaining a target voice input, controlling the target match mark to switch back to a state of displaying the target session item.

In some embodiments, the display switching module 410 is used to perform at least one of the following:

In response to obtaining a second track operation acting on a first session item in the session window, controlling the first session item to switch from a current fully displayed state to a hidden state or a partially displayed state;

In response to obtaining at least two track operations acting on a second session item in the session window, controlling the second session item and at least one third session item associated with it to switch from a current fully displayed state to a hidden state or a partially displayed state;

In response to obtaining an operation of sharing the session window with a second target device, controlling at least one fourth session item including the target word and/or at least one fifth session item representing the target content in the session window to switch from a fully displayed state to a hidden state or a partially displayed state.

The description of the device embodiments is similar to the description of the method embodiments, and has similar beneficial effects as the method embodiments. In some embodiments, the functions or modules included in the device provided by the embodiments of the present disclosure may be used to execute the method described in the method embodiments. Technical details not described in the device embodiments of the present disclosure may be found with reference to the description of the method embodiments of the present disclosure.

When the display control method is implemented in the form of a software function module and sold or used as an independent product, the display control method may also be stored in a computer-readable storage medium. The technical solution of some embodiments of the present disclosure may be reflected in the form of a software product that contributes to the relevant technology. The software product is stored in a storage medium, including several instructions to enable a computer device (which may be a personal computer, a server, or a network device, or the like) to execute all or part of the methods described in some embodiments of the present disclosure. The storage medium may include: various media that may store program codes, such as a U disk, a mobile hard disk, a read-only memory (ROM), a disk or an optical disk. Embodiments of the present disclosure are not limited to any specific hardware, software or firmware, or any combination of hardware, software, and firmware.

Some embodiments of the present disclosure provide a computer device, including a memory and a processor, where the memory stores a computer program that may be run on the processor, and the processor implements some or all of the steps in the method when executing the program.

Some embodiments of the present disclosure provide a computer-readable storage medium, on which a computer program is stored, and when the computer program is executed by the processor, some or all of the steps in the method are implemented. The computer-readable storage medium may be transient or non-transient.

Some embodiments of the present disclosure provide a computer program, including a computer-readable code. When the computer-readable code is run in a computer device, a processor in the computer device executes some or all of the steps for implementing the method.

Some embodiments of the present disclosure provide a computer program product, which includes a non-transitory computer-readable storage medium storing a computer program, and when the computer program is read and executed by a computer, some or all of the steps in the method are implemented. The computer program product may be implemented in hardware, software, or a combination thereof. In some embodiments, the computer program product is embodied as a computer storage medium, and in other embodiments, the computer program product is embodied as a software product, such as a software development kit (SDK), or the like.

Some embodiments of the present disclosure may emphasize the differences between the various embodiments, and the same or similar aspects may be referenced to each other. The description of the device, storage medium, computer program and computer program product embodiments are similar to the description of the method embodiments, and have similar beneficial effects as the method embodiments. Technical details not described in the embodiments of the device, storage medium, computer program and computer program product may be found with reference to the description of the method embodiments.

FIG. 5 is a schematic diagram of a hardware entity of a computer device in some embodiments of the present disclosure. As shown in FIG. 5, the hardware entity of the computer device 500 includes: a processor 501, a communication interface 502, and a memory 503, where:

The processor 501 generally controls the overall operation of the computer device 500.

The communication interface 502 enables the computer device to communicate with other terminals or servers through a network.

The memory 503 is configured to store instructions and applications executable by the processor 501, and may also cache data to be processed or processed by the processor 501 and each module in the computer device 500 (in some embodiments, image data, audio data, voice communication data, and video communication data), which may be implemented by flash memory (FLASH) or random access memory (Random Access Memory, RAM). Data may be transmitted between the processor 501, the communication interface 502, and the memory 503 through the bus 504.

Terms such as “one embodiment” or “an embodiment” or “some embodiments” or “embodiments” refer to that features, structures or characteristics related to the embodiment are included in at least one embodiment of the present disclosure. Therefore, “in one embodiment” or “in an embodiment” or “in certain embodiments” does not necessarily refer to the same embodiment. In addition, these features, structures or characteristics may be combined in one or more embodiments in any suitable manner. Various embodiments of the present disclosure, the size of the serial number of each step/process as applicable does not necessarily mean the order of execution, and the execution order of each step/process may be determined by its function and internal logic, and should not constitute any limitation on the implementation process of the embodiments of the present disclosure. The serial numbers of the embodiments of the present disclosure are for description only and do not necessarily represent the advantages and disadvantages of the embodiments.

Terms such as “include” or “comprise” or any other variations thereof may cover non-exclusive inclusion, so that a process, method, article or device including a series of elements may include not only those elements, but also other elements not explicitly listed, or may include elements inherent to such process, method, article or device. In the absence of further restrictions, an element defined by the sentence “include a” or “comprise a . . . ” does not exclude the existence of other identical elements in the process, method, article or device including the element.

The devices and methods may be implemented in other ways. The device embodiments described herein are schematic. Division of the units is a logical function division. There may be other division methods in an implementation, such as: multiple units or components may be combined, or may be integrated into another system, or some features may be ignored or not executed. In addition, the coupling, direct coupling, or communication connection between the components shown or discussed may be through interfaces, and the indirect coupling or communication connection of the devices or units may be electrical, mechanical or other forms.

The units described as separate components may or may not be physically separated, and the components displayed as units may or may not be physical units; they may be located in one place or distributed on multiple network units; some or all of the units may be selected for performance in some embodiments.

Certain functional units may be integrated into one processing unit, or each unit may be separately used as a unit, or two or more units may be integrated into one unit; the integrated units may be implemented in the form of hardware or in the form of hardware plus software functional units.

All or part of the steps of implementing the method embodiments may be performed by hardware related to program instructions, and the program may be stored in a computer-readable storage medium. When executed, the program executes the steps of the method embodiments; and the storage medium includes: a mobile storage device, a read-only memory (ROM), a magnetic disk or an optical disk, and/or other media that may store program codes.

When the integrated unit in some embodiments of the present disclosure is implemented in the form of a software function module and sold or used as an independent product, the integrated unit may also be stored in a computer-readable storage medium. The technical solution according to some embodiments of the present disclosure may be embodied in the form of a software product, which is stored in a storage medium and includes a number of instructions for a computer device (which may be a personal computer, server, or network device, or the like) to execute all or part of the methods. The storage medium includes: various media that may store program codes, such as mobile storage devices, ROMs, magnetic disks, or optical disks.

The above illustrates certain implementation method(s) of the present disclosure, but the protection scope of the present disclosure is not limited thereto. Changes and/or substitutions within the technical scope may be adopted and should be included in the protection scope of the present disclosure.

What is claimed is:

1. A display control method, comprising:
in response to a target event, controlling a target session item in a session window of a first application executing an interactive task to switch from a first display state to a second display state,
wherein, the target session item is less identifiable in the second display state than in the first display state.

2. The method of claim 1, further comprising:
determining a target session item from the session window of the first application based on the target event,
wherein determining the target session item from the session window of the first application based on the target event includes one or more of:
in response to obtaining a target gesture operation acting on the session window, determining at least one session item identified by the target gesture operation as the target session item;
in response to obtaining a voice input operation acting on the session window, determining at least one session item identified by the voice input operation as the target session item;
in response to obtaining a string input operation acting on the session window, determining at least one session item identified by the string input operation as the target session item; or
in response to obtaining target reference data, determining at least one session item in the session window that includes a target word or represents a target content as the target session item.

3. The method of claim 2, wherein determining at least one session item identified by the target gesture operation as the target session item comprises one or both of:
in response to obtaining a track operation acting on a first session item in the session window, determining the first session item as the target session item; or
in response to obtaining at least two track operations acting on a second session item in the session window, determining the second session item and at least one third session item associated with the second session item as the target session item.

4. The method of claim 2, wherein determining at least one session item in the session window that includes the target word or represents the target content as the target session item comprises one or more of:
in response to entering a target time period, determining at least one session item in the session window including the target word or representing the target content as the target session item;
in response to an electronic device entering a target space area, determining at least one session item in the session window including the target word or representing the target content as the target session item;
in response to a change of user of the electronic device, determining at least one session item in the session window including the target word or representing the target content as the target session item;
in response to a change in a connection state between the electronic device and a first target device, determining at least one session item in the session window including the target word or representing the target content as the target session item;
in response to a change in a usage mode of the electronic device, determining at least one session item in the session window including the target word or representing the target content as the target session item; or
in response to obtaining an operation to share the session window with a second target device, determining at least one session item in the session window including the target word or representing the target content as the target session item,
wherein the electronic device is a device running the first application.

5. The method of claim 1, wherein controlling the target session item in the session window of the first application executing the interactive task to switch from the first display state to the second display state comprises one or more of:
controlling a first session item in the session window to switch from a full display state to a hidden state or a partial display state;
controlling a second session item in the session window to switch from a first display parameter to a second display parameter; or
controlling the second session item in the session window and at least one third session item associated with the second session item to switch from the first display state to the second display state.

6. The method of claim 5, wherein controlling the second session item in the session window to switch from the first display parameter to the second display parameter comprises one or more of:
controlling the second session item to switch from being displayed in a first display area to being displayed as a symbol mark without text information or image information;
controlling a display size of the second session item to switch from a first display size to a second display size, wherein the second display size is smaller than the first display size;
controlling display transparency of at least a portion of the second session item to switch from a first transparency to a second transparency, wherein the second transparency is greater than the first transparency; or
masking at least a portion of the second session item.

7. The method of claim 1, further comprising one or more of:
after controlling the second session item and at least one third session item to switch to the corresponding symbol mark, displaying the symbol mark of the second session item, displaying a symbol mark set at the location of the second session item, or associating a symbol mark of the third session item with a folded space or drop-down box of the symbol mark of the second session item;
based on attribute information and/or evaluation information of the target session item, performing privacy processing to switch the target session item to the second display state; or
in response to obtaining a target input operation, switching the target session item back from the second display state to the first display state.

8. The method of claim 7, wherein switching the target session item from the second display state back to the first display state comprises one or more of:
in response to obtaining a first track operation acting on the first session item in the session window, controlling the first session item to switch back from a hidden state or a partially displayed state to a fully displayed state;
in response to obtaining a click operation of a symbol mark acting on the second session item in the session window, controlling the symbol mark to switch back to fully displaying the second session item; or
in response to obtaining a trigger operation of a key combination acting on an electronic device or obtaining a target voice input, controlling target symbol mark to switch back to a state of displaying the target session item.

9. The method of claim 1, wherein controlling the target session item in the session window of the first application executing the interactive task to switch from the first display state to the second display state comprises one or more of:
in response to obtaining a second track operation acting on a first session item in the session window, controlling the first session item to switch from the full display state to the hidden state or the partially displayed state;
in response to obtaining at least two track operations acting on a second conversation item in the session window, controlling the second conversation item and at least one third conversation item associated with the second session item to switch from the full display state to the hidden state or the partially displayed state; or
in response to obtaining an operation of sharing the session window with a second target device, controlling at least one fourth session item including the target word and/or at least one first session item representing the target content in the session window to switch from the full display state to the hidden state or the partially displayed state.

10. A display control device, comprising:
a display switching module, for controlling a target session item in a session window of a first application executing an interactive task to switch from a first display state to a second display state in response to a target event,
wherein the target session item is less identifiable in the second display state than in the first display state.

11. A display control device, comprising: a memory storing computer program instructions; and a processor coupled to the memory and configured to execute the computer program instructions and perform:
in response to a target event, controlling a target session item in a session window of a first application executing an interactive task to switch from a first display state to a second display state,
wherein, the target session item is less identifiable in the second display state than in the first display state.

12. The display control device of claim 11, wherein the processor is further configured to:
determining a target session item from the session window of the first application based on the target event,
wherein determining the target session item from the session window of the first application based on the target event includes one or more of:
in response to obtaining a target gesture operation acting on the session window, determining at least one session item identified by the target gesture operation as the target session item;
in response to obtaining a voice input operation acting on the session window, determining at least one session item identified by the voice input operation as the target session item;
in response to obtaining a string input operation acting on the session window, determining at least one session item identified by the string input operation as the target session item; or
in response to obtaining target reference data, determining at least one session item in the session window that includes a target word or represents a target content as the target session item.

13. The display control device of claim 12, wherein determining at least one session item identified by the target gesture operation as the target session item includes one or both of:
in response to obtaining a track operation acting on a first session item in the session window, determining the first session item as the target session item; or
in response to obtaining at least two track operations acting on a second session item in the session window, determining the second session item and at least one third session item associated with the second session item as the target session item.

14. The display control device of claim 12, wherein determining at least one session item in the session window that includes the target word or represents the target content as the target session item includes one or more of:
in response to entering a target time period, determining at least one session item in the session window including the target word or representing the target content as the target session item;
in response to an electronic device entering a target space area, determining at least one session item in the session window including the target word or representing the target content as the target session item;
in response to a change of user of the electronic device, determining at least one session item in the session window including the target word or representing the target content as the target session item;
in response to a change in a connection state between the electronic device and a first target device, determining at least one session item in the session window including the target word or representing the target content as the target session item;
in response to a change in a usage mode of the electronic device, determining at least one session item in the session window including the target word or representing the target content as the target session item; or
in response to obtaining an operation to share the session window with a second target device, determining at least one session item in the session window including the target word or representing the target content as the target session item,
wherein the electronic device is a device running the first application.

15. The display control device of claim 11, wherein controlling the target session item in the session window of the first application executing the interactive task to switch from the first display state to the second display state includes one or more of:
controlling a first session item in the session window to switch from a full display state to a hidden state or a partial display state;
controlling a second session item in the session window to switch from a first display parameter to a second display parameter; or
controlling the second session item in the session window and at least one third session item associated with the second session item to switch from the first display state to the second display state.

16. The display control device of claim 15, wherein controlling the second session item in the session window to switch from the first display parameter to the second display parameter includes one or more of:
controlling the second session item to switch from being displayed in a first display area to being displayed as a symbol mark without text information or image information;
controlling a display size of the second session item to switch from a first display size to a second display size, wherein the second display size is smaller than the first display size;
controlling display transparency of at least a portion of the second session item to switch from a first transparency to a second transparency, wherein the second transparency is greater than the first transparency; or
masking at least a portion of the second session item.

17. The display control device of claim 11, wherein the processor is further configured to perform one or more of:
after controlling the second session item and at least one third session item to switch to the corresponding symbol mark, displaying the symbol mark of the second session item, displaying a symbol mark set at the location of the second session item, or associating a symbol mark of the third session item with a folded space or drop-down box of the symbol mark of the second session item;
based on attribute information and/or evaluation information of the target session item, performing privacy processing to switch the target session item to the second display state; or
in response to obtaining a target input operation, switching the target session item back from the second display state to the first display state.

18. The display control device of claim 17, wherein switching the target session item from the second display state back to the first display state includes one or more of:
in response to obtaining a first track operation acting on the first session item in the session window, controlling the first session item to switch back from a hidden state or a partially displayed state to a fully displayed state;
in response to obtaining a click operation of a symbol mark acting on the second session item in the session window, controlling the symbol mark to switch back to fully displaying the second session item; or
in response to obtaining a trigger operation of a key combination acting on an electronic device or obtaining a target voice input, controlling target symbol mark to switch back to a state of displaying the target session item.

19. The display control device of claim 11, wherein controlling the target session item in the session window of the first application executing the interactive task to switch from the first display state to the second display state includes one or more of:
in response to obtaining a second track operation acting on a first session item in the session window, controlling the first session item to switch from the full display state to the hidden state or the partially displayed state;
in response to obtaining at least two track operations acting on a second conversation item in the session window, controlling the second conversation item and at least one third conversation item associated with the second session item to switch from the full display state to the hidden state or the partially displayed state; or
in response to obtaining an operation of sharing the session window with a second target device, controlling at least one fourth session item including the target word and/or at least one first session item representing the target content in the session window to switch from the full display state to the hidden state or the partially displayed state.

20. The display control device of claim 11, wherein the identifiability is associated with a font size, the font size in the second display state being smaller than a font size in the first display state.
